(19) United States
(12) Patent Application Publication
(10) Pub. No.: US 2007/0034751 A1
(43) Pub. Date: Feb. 15, 2007

(54) Device for mounting a pair of plumbing pipes and a method of mounting such a pair of pipes

(76) Inventor: Robert Trickett, Loughboroughn (GB)

Correspondence Address: NIKOLAI & MERSEREAU, P.A., 900 SECOND AVENUE SOUTH, SUITE 820, MINNEAPOLIS, MN, 55402, US

(21) Appl. No.: 11/233,713

(22) Filed: Sep. 23, 2005

(30) Foreign Application Priority Data
Aug. 13, 2005 (GB) 0516674.9

(51) Int. Cl. F16L 5/00

(52) U.S. Cl. 248/56; 248/300

(57) ABSTRACT

In the field of plumbing there is a need for a device which simplifies the installation of respective end portions of a pair of plumbing pipes prior to connection to a plumbing fixture.

A device (D1; D2; D3; D4), for mounting respective end portions of a pair of plumbing pipes (10, 12) on a first support surface (SW), wherein each end portion is for connection to a plumbing fixture (R) which is mountable on one of the first support surface (SW) or a second, adjacent support surface. The device (D1; D2; D3; D4) is in the form of a template (18) to which each end portion can be attached. The template (18) has at least one pair of pipe location sites (PL). Each pipe location site (PL) is for positively locating a respective end portion on the template (18). The template (18) is adapted for securance to said first support surface (SW) with said pair of end portions located thereon in order to positively position said pair of end portions relative to one another and to said first support surface (SW).

The present invention relates, in particular but not exclusively, to a device for facilitating mounting of a pair of plumbing pipes and a method of mounting such pipes.

Heating of the interior space of buildings is commonly achieved by the use of radiators mounted on the internal walls of the building. The radiators form part of a central heating system wherein a heated medium, usually water, is fed to and returned from each radiator by a pair of respective feed and return pipes.

The normal procedure when installing a radiator onto a new wall involves first mounting the feed and return pipes onto the wall so that their terminal ends or ‘tails’ which are intended to be connected to the radiator are accurately positioned relative to one another.

Usually such positioning is done to ensure that the respective tails of the feed and return pipes are accurately spaced apart in a horizontal direction by a desired amount and that the tails are located on the same horizontal plane. This can be particularly difficult if the wall is uneven and/or is made from poor brickwork.

Usually after mounting the feed and return pipes on the wall, the wall is then covered with a surfacing material such as a layer of plaster. This layer of plaster usually covers the feed and return pipes leaving only their tails exposed for later connection to the radiator.

Unfortunately when such a layer of plaster is applied it is not unusual for the position of the pipes to be accidentally altered. Subsequently, after setting of the plaster re-adjustment of the position of the tails of the pipes might be required and such re-adjustment can cause cracking of the plaster, requiring in severe cases replacement of the plaster.

In addition, various other plumbing fixtures such as sinks and shower mixers require plumbing with respective hot and cold feed pipes. The need to connect such fixtures to an accurately spaced and positioned pair of feed pipes presents the same installation difficulties as outlined above in connection with the installation of radiators.

A general aim of the present invention is to provide a device for simplifying the installation of respective end portions of a pair of plumbing pipes prior to connection to a plumbing fixture.

According to a first aspect of the present invention there is provided a device, for mounting respective end portions of a pair of plumbing pipes on a first support surface, each end portion being for connection to a plumbing fixture mountable on one of the first support surface or a second, adjacent support surface, the device being in the form of a template to which each end portion can be attached, the template having at least one pair of pipe location sites, each pipe location site being for positively locating a respective end portion on the template, the template being adapted for securance to said first support surface with said pair of end portions located thereon in order to positively position said pair of end portions relative to one another and to said first support surface.

According to a second aspect of the present invention there is provided a method of mounting respective end portions of a pair of plumbing pipes on a first support surface, for subsequent connection to a plumbing fixture which is to be mounted on one of said first support surface or a second, adjacent support surface, the method including the following steps:

(i) locating each end portion onto a device as defined above; and

(ii) positioning the device at a desired position relative to the first support surface and subsequently securing the device to the first support surface at said desired position,

steps (i) and (ii) being performed in either order.

Various aspects of the present invention are hereinafter described with reference to the accompanying drawings in which:

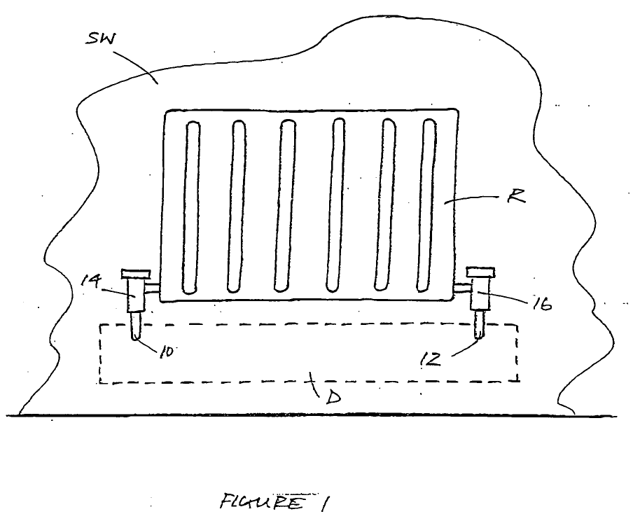

FIG. 1 is a schematic diagram showing a device according to a first embodiment of the present invention and a radiator attached to a support wall;

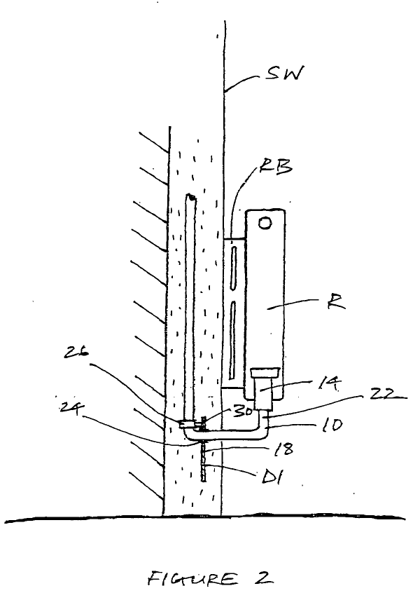

FIG. 2 is a sectional, partial, side view of the device and radiator shown in FIG. 1;

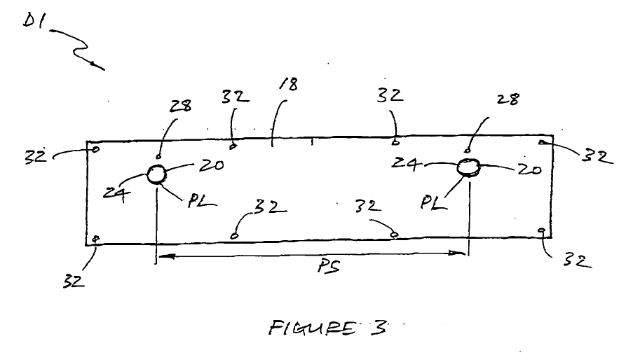

FIG. 3 is a front view of a device according to the first embodiment of the present invention; and

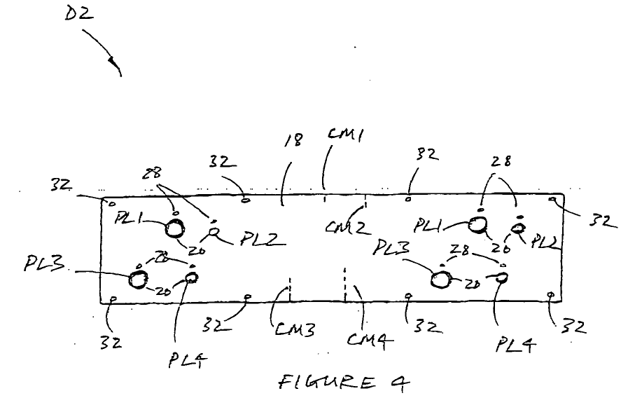

FIG. 4 is a front view of a device according to a second embodiment of the present invention;

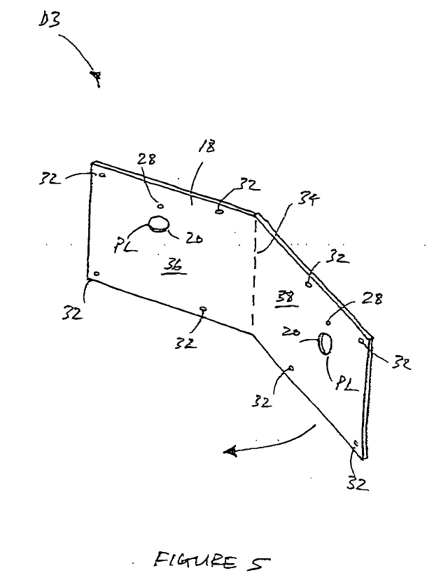

FIG. 5 is a perspective view of a device according to a third embodiment of the present invention; and

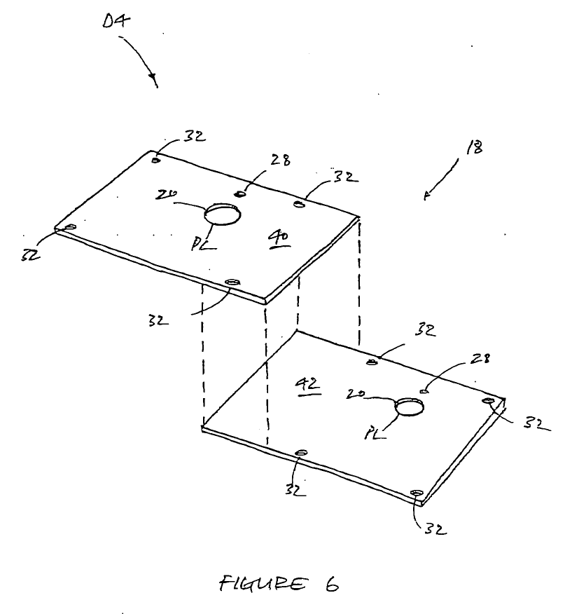

FIG. 6 is a front view of a device according to a fourth embodiment of the invention.

Referring initially to FIG. 1 there is shown a radiator R mounted on a support surface, i.e. a support wall SW in a conventional manner, e.g. by conventional radiator brackets RB (FIG. 2).

The support wall SW shown is a solid wall. Other embodiments of the invention are usable with other wall types, e.g. studded walls.

The radiator is connected to a feed pipe 10 and a return pipe 12 via respective valves 14, 16.

The feed and return pipes 10, 12 are mounted on a device D according to the present invention which in turn is secured to the support wall SW at a desired position in order to positively position the feed and return pipes 10, 12 relative to one another and to the wall.

In the above arrangement the device D and the radiator R are secured to the same support surface, i.e. the support wall SW.

However, it is also possible to secure the device D to a first support surface and the radiator R or other plumbing fixture to a second, separate, adjacent support surface, for example when the first support surface is a floor and the second support surface is a support wall SW.

A first embodiment of a device D1 according to the present invention is illustrated in FIGS. 2 and 3.

The device shown in FIGS. 2 and 3 is in the form of a template 18 which is preferably formed from a plate of material which is sufficiently rigid to act as a mounting support for the feed and return pipes 10, 12, i.e. the plate of material is sufficiently rigid to retain the pipes 10, 12 in place when attached to the template 18 and when the template 18 is attached to the support wall SW.

For example, the template may be formed from a plate of metal (such as steel) or a suitable rigid plastics material.

The template 18 is provided with a pair of pipe location sites PL for receiving the feed and return pipes 10, 12 respectively. In the first embodiment, each location site PL is in the form of an aperture 20.

Each pipe 10,12 is provided with an elbowed end portion or tail 22 which extends at 90 degrees from the remainder of the pipe 10, 12. Accordingly, as seen in FIG. 2, the tail 22 is able to pass through the aperture 20 perpendicularly relative to the surface of the support wall SW whilst the remainder of the pipe 10, 12 is able to extend generally parallel to the surface of the wall SW. In the example shown the remainder of each pipe 10, 12 extends vertically. In other embodiments of the invention the remainder of each pipe 10, 12 may extend in a differing direction, e.g. downwards, to the left, or to the right.

The apertures 20 are spaced horizontally apart by a predetermined distance PS so as to space the tails 22 of pipes 10,12 emerging therefrom by a predetermined spacing suitable for enabling the tails 22 to be subsequently connected to a radiator or other plumbing fixture of a predetermined width.

The apertures 20 are preferably of a size substantially the same as that of the pipe tails 22 such that the tails 22 pass through their respective apertures 20 with little clearance. This relationship assists in restricting relative movement between the tails 22 and the template 18 and so minimises any undesired change in the horizontal spacing between the tails 22 of the feed and return pipes 10, 12

The template 18 may also include a grommet 24 lining each aperture 20 so as to prevent chafing of each pipe 10, 12 as it is passed therethrough and to help positionally locate each pipe 10, 12 relative to the template 18.

Preferably the pipes 10,12 are each attached to the rear of the template 18 via a pipe clip 26. The pipe clip 26 is conveniently a conventional pipe clip 26 as normally used for securing pipes to a support wall.

Preferably the template 18 is provided with at least one screw aperture 28 spaced from each aperture 20 to enable a screw 30 to be passed therethrough so as to secure each pipe clip 26 to the template 18. In the embodiment shown each screw aperture 28 is spaced above a corresponding aperture 20. Spacing the or each screw aperture 28 to the left, right, below, or otherwise as desired from the aperture 20 is also possible so as to allow the remainder of each pipe 10, 12 to extend in a corresponding direction.

Each pipe clip 26 advantageously helps to prevent lateral movement of a given tail 22 in any direction relative to the template 18.

Preferably the template 18 includes a plurality of fixing apertures 32 to allow an installer to fix the template 18 to the support wall SW using, e.g. screws or nails.

A device D2 according to a second embodiment of the invention is shown in FIG. 4. The second device D2 shares common features with the first device D1. Such features share the same reference numerals.

In addition, the second device D2 includes four respective pairs of pipe location sites PL1, PL2, PL3, PL4, each pair corresponding to a respective type of plumbing pipe such as, e.g. 8 mm, 10 mm or 15 mm copper pipe; copper end feed pipe; Yorkshire pipe; Speedfit® pipe; or Hep20® pipe.

As a result, a single second device D2 is useable with a range of differing plumbing pipe types, thereby providing an installer with a range of installation options for a given plumbing fixture.

The template 18 of the second device D2 includes a plurality of centre marks CM1, CM2, CM3, CM4, each corresponding to a respective pair of pipe location sites PL1, PL2, PL3, PL4. During installation a given centre mark CM1, CM2, CM3, CM4 assists an installer in correctly positioning the corresponding pair of pipe location sites PL1, PL2, PL3, PL4 so as to position the tail 22 of each pipe 10, 12 at a desired location for subsequent connection to a plumbing fixture.

In a further device D3 according to a third embodiment of the invention, the template 18 is foldable about a predetermined hinge axis 34 so as to allow a first portion 36 of the template 18 to overlie a second portion 38 of the template 18, as shown in FIG. 5.

The adoption of such a configuration is useful when packaging the template 18 with e.g. a radiator as part of a fixing kit, since it reduces the overall length of the template, thereby reducing the size of package required to accommodate the radiator and the template 18.

Alternatively, in a still further device D4 according to a fourth embodiment of the invention, the template 18 includes separate third and fourth portions 40, 42, as shown in FIG. 6. The third and fourth portions 40, 42 are fastenable to one another, using e.g. nuts and bolts, clips, adhesive, tape, etc, so as to define a rigid template 18.

This arrangement allows each portion 40, 42 to lie over one another while packaged so as to reduce the length of package required.

In use, an installer mounts a pair of plumbing pipes 10, 12 on a support wall SW, for subsequent connection to a plumbing fixture, e.g. radiator R, which is also to be mounted on the wall SW, by:

(i) locating each plumbing pipe 10, 12 onto a device D1, D2, D3, D4 as defined above; and

(ii) positioning the device D1, D2, D3, D4 at a desired position relative to the support wall SW and subsequently securing the device D1, D2, D3, D4 to the support wall SW at the desired position.

The installer may perform steps (i) and (ii) in either order.

Alternatively, an installer may mount a pair of plumbing pipes 10, 12 on a floor, for subsequent connection to a plumbing fixture which is to be mounted on an adjacent support wall SW, using steps corresponding to those outlined above.

Accordingly, the invention allows and installer to position and fix in place respective tails 22 of a pair of plumbing pipes 10, 12, such that they are accurately spaced apart from one another in a horizontal direction by a desired amount, and are located in the same plane.

1. A device, for mounting respective end portions of a pair of plumbing pipes on a first support surface, each end portion being for connection to a plumbing fixture mountable on one of the first support surface or a second, adjacent support surface, the device being in the form of a template to which each end portion can be attached, the template having at least one pair of pipe location sites, each pipe location site being for positively locating a respective end portion on the template, the template being adapted for securance to said first support surface with said pair of end portions located thereon in order to positively position said pair of end portions relative to one another and to said first support surface.

2. A device according to claim 1 wherein each pipe location site is in the form of an aperture.

3. A device according to claim 1 wherein the template includes a pair of pipe clips, each securable thereto spaced from a respective pipe location site, for attaching an end portion of a respective plumbing pipe to the template.

4. A device according to claim 1 wherein the template includes a pair of grommets, each grommet lining a respective aperture.

5. A device according to claim 1 including two or more pairs of pipe location sites.

6. A device according to claim 1 wherein the template includes at least one centre mark equally spaced from each of a corresponding pair of pipe location sites.

7. A device according to claim 1 wherein the template includes at least two portions hingedly connected to one another so as to pivot relative to one another about a predetermined hinge axis.

8. A device according to claim 1 wherein the template includes at least two separate portions, fastenable to one another so as to define a rigid plate.

9. A method of mounting respective end portions of a pair of plumbing pipes on a first support surface, for subsequent connection to a plumbing fixture which is to be mounted on one of said first support surface or a second, adjacent support surface, the method including the following steps:
(i) locating each end portion onto a device as defined above; and
(ii) positioning the device at a desired position relative to the first support surface and subsequently securing the device to the first support surface at said desired position,
steps (i) and (ii) being performed in either order.
